(19) United States
(12) Patent Application Publication
(10) Pub. No.: US 2007/0163659 A1
(43) Pub. Date: Jul. 19, 2007

(54) Fuel tank

(75) Inventors: Shoji Uhara, Saitama (JP); Masakazu Kitamoto, Saitama (JP); Gaku Hatano, Saitama (JP); Koichi Hidano, Saitama (JP); Masaaki Horiuchi, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/653,723

(22) Filed: Jan. 16, 2007

(30) Foreign Application Priority Data
Jan. 17, 2006 (JP) 2006-008635
Jan. 17, 2006 (JP) 2006-008636

(51) Int. Cl. B01D 47/00; E03B 11/00

(52) U.S. Cl. 137/565.17; 137/571

(57) ABSTRACT

A fuel tank includes a component, a reservoir unit having a fuel pump, a tank body formed with an opening through which the reservoir unit and the component are inserted, a flange operable to close the opening, and an extensible connecting unit which connects a lower face of the flange and the reservoir unit. The extensible connecting unit includes a first sliding member which is slidable with respect to the reservoir unit in a vertical direction, and a second sliding member which is slidable with respect to the first sliding member, and is attached to the lower face of the flange.

The present invention claims priority from Japanese patent applications no. 2006-008635 and No. 2006-008636, both filed on Jan. 17′, 2006, the entire contents of which are incorporated herein by reference.

### BACKGROUND OF THE INVENTION

1. Field of the Invention

The present invention relates to a fuel tank having a tank body formed with an opening at an upper wall thereof, a reservoir unit provided with a fuel pump, and some kind of component, in which the reservoir unit and the component are inserted inside the tank body through the opening, and the opening is closed with a flange.

2. Description of the Related Art

JP-A-2004-257381 discloses a fuel tank having a hole formed on an upper face thereof, and a module flange which closes the hole. A component is fixed onto a lower face of the module flange, and a reservoir housing a fuel pump is connected to the module flange by an extensible attaching means. After inserting the reservoir into the fuel tank from the hole, the extensible attaching means is contracted so that the hole can be closed with the module flange. In this way, a size of the hole of the fuel tank can be made small, and the reservoir and the component are assembled inside the fuel tank so as not to interfere with each other.

However, the extensible attaching means that connects the reservoir and the module flange includes a shaft which slidably penetrates the reservoir and is fixed onto the lower face of the module flange, and a compressive spring which is attached onto an outer circumference of the shaft and pushes the reservoir in a direction in which the reservoir moves away from the module flange. Therefore, a relative sliding distance between the reservoir and the module flange is not sufficiently ensured. Accordingly, in a case where a vertical dimension of the component is long, a lower end portion of the component may interfere with an upper wall of the fuel tank before the reservoir is completely inserted into the hole of the fuel tank, whereby posing a problem that the reservoir and the component cannot be assembled.

### SUMMARY OF THE INVENTION

It is an object of the present invention to provide a fuel tank, in which a reservoir unit and a vertically long component can be assembled through an opening formed on an upper face of a tank body.

According a first aspect of the invention, a fuel tank includes: a component; a reservoir unit having a fuel pump; a tank body formed with an opening through which the reservoir unit and the component are inserted; a flange operable to close the opening; and an extensible connecting unit which connects a lower face of the flange and the reservoir unit. The extensible connecting unit includes: a first sliding member which is slidable with respect to the reservoir unit in a vertical direction; and a second sliding member which is slidable with respect to the first sliding member, and is attached to the lower face of the flange. The component is disposed on the lower face of the flange at a position that is offset with respect to the reservoir unit in a horizontal direction. A height of the tank body may be shorter than a sum of respective heights of the component and the reservoir. The opening may have a size, through which the reservoir unit and the component can be individually inserted, and through which the reservoir unit and the component can not be simultaneously inserted.

According a second aspect of the invention, the first sliding member and the second sliding member may be telescopically engaged with each other.

According a third aspect of the invention, the fuel tank may further include a biasing member operable to bias the first sliding member in a direction where the first sliding member protrudes upward from the reservoir.

According a fourth aspect of the invention, the fuel tank may further include a cap that is attachable to a periphery of the opening, and the flange may be fixed between the cap and the tank body.

According a fifth aspect of the invention, the component may include a sub-tank operable to liquidize vaporized fuel generated in the tank body and to return the liquidized fuel into the tank body.

According a sixth aspect of the invention, the component and the flange may be formed in a one-piece structure.

According a seventh aspect of the invention, a fuel tank includes: a tank body operable to store fuel; and a pump module operable to pump the fuel. The pump module includes a sub-tank operable to liquidize vaporized fuel generated in the tank body and to return the liquidized fuel into the tank body, and the sub-tank is disposed inside the tank body.

According an eighth aspect of the invention, the pump module may further include: a flange operable to close an opening that is formed on the tank body; a reservoir unit; and an extensible connecting unit which connects a lower face of the flange and the reservoir unit. The extensible connecting unit may include: a first sliding member which is slidable with respect to the reservoir unit in a vertical direction; and a second sliding member which is slidable with respect to the first sliding member, and is attached to the lower face of the flange. The sub-tank is disposed on the lower face of the flange at a position that is offset with respect to the reservoir unit in a horizontal direction. The opening may have a size, through which the reservoir unit and the sub-tank can be individually inserted, and through which the reservoir unit and the sub-tank can not be simultaneously inserted.

According a ninth aspect of the invention, the sub-tank and the flange may be formed in a one-piece structure.

According a tenth aspect of the invention, the fuel tank may further include a cap that is attachable to a periphery of the opening, and the flange may be fixed between the cap and the tank body.

According one or more aspects of the invention, the reservoir unit is inserted from the opening of the tank body and is moved in a lateral direction inside the tank body. Subsequently, while the extensible connecting unit is being contracted, the component is inserted from the opening into the tank body. Thereafter, the opening of the tank body is closed with the flange. Therefore, while a size of the opening is being reduced to the minimum size, the reservoir unit and the component can be assembled within the tank body. Further, a leakage of vaporized fuel from the periphery of the flange that closes the opening can be suppressed to minimum. Furthermore, since the extensible connecting unit includes the first sliding member and the second sliding member, even when a vertical dimension of the tank body is short and a vertical dimension of the component is large, the component can be inserted into the tank body without causing any problems by sufficiently contracting the extensible connecting unit from an extended state.

According one or more aspects of the invention, the first and the second sliding member are telescopically engaged with each other. Therefore, the reservoir unit can be guided in the vertical direction with respect to the flange with a simple structure.

According one or more aspects of the invention, the biasing member biases the first sliding member in a direction where the first sliding member protrudes upward from the reservoir. Accordingly, the reservoir unit can be pushed onto the lower wall of the tank body by a reaction force of pushing an end portion of the first sliding member onto the lower face of the flange. Therefore, an increase and decrease in the height of the tank body caused by a change in the inner pressure can be absorbed.

According one or more aspects of the invention, the sub-tank operable to liquidize vaporized fuel generated in the tank body and to return the liquidized fuel into the tank body is included in the pump module operable to pump fuel from the tank body, and is disposed inside the tank body. Therefore, the pump module and the sub-tank can be assembled all at once so that the number of man-hours required for the assembling work can be reduced. Further, it becomes unnecessary to provide means for fixing the sub-tank separately from means for fixing the pump module. Furthermore, it becomes unnecessary to conduct a joining work of joining a pipe for connecting the sub-tank with the tank body at the time of mounting the tank body on a vehicle body, thereby preventing the vaporized fuel from being transmitted through the pipe and dispersed into the atmosphere. Furthermore, the number of openings provided on the tank body can be reduced from two to one. Accordingly, a quantity of vaporized fuel transmitted through the flange that closes the opening can be reduced.

### BRIEF DESCRIPTION OF THE DRAWINGS

Advantages, nature, and various additional features of the invention will appear more fully upon consideration of an exemplary embodiment. The exemplary embodiment is set forth in the following drawings.

FIG. 1 is a view showing a state in which a pump module is installed to a tank body;

FIG. 2 is a view taken on line II-II in FIG. 1;

FIG. 3 is a sectional view taken on line III-III in FIG. 2;

FIG. 4 is a view showing a state in which an extensible connecting unit is extended;

FIG. 5 is a schematic view showing a structure of a tank body and sub-tank;

FIG. 6 is a schematic view for explaining an action at the time of assembling a pump module; and

FIG. 7 is a schematic view for explaining an action at the time of assembling a pump module.

### DESCRIPTION OF THE EXEMPLARY EMBODIMENT

Hereinafter, an exemplary embodiment of the invention will be explained with reference to the drawings, the following exemplary embodiments do not limit the scope of the invention.

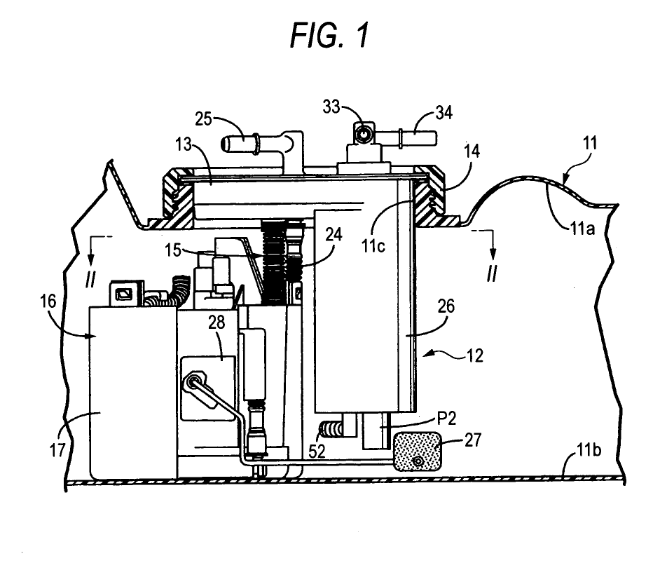

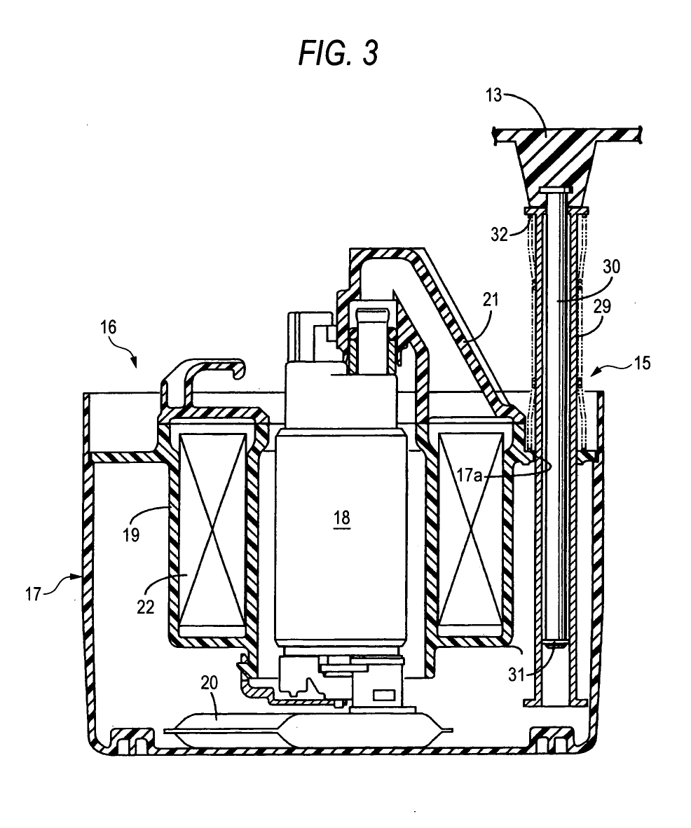

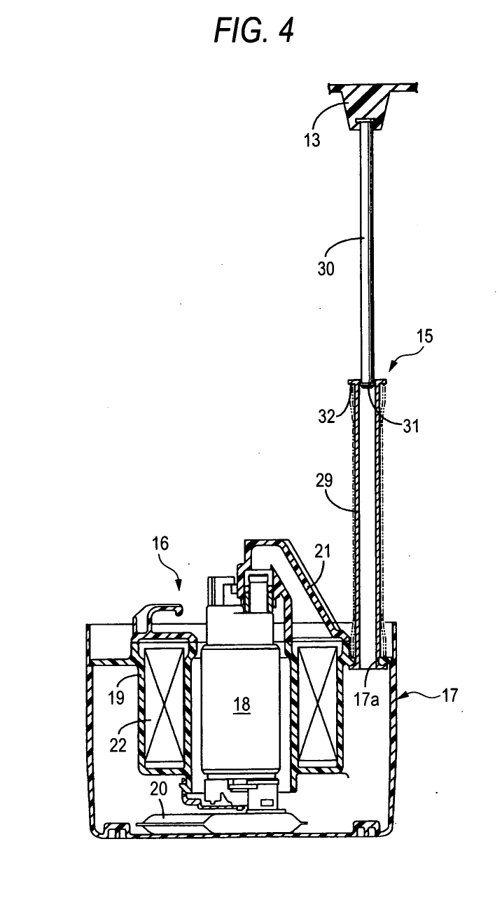

As shown in FIGS. 1 to 4, a pump module 12 is installed in a tank body 11 of a vehicle fuel tank made of synthetic resin. The pump module 12 is an in-tank type pump module, and supplies fuel to an engine. The tank body 11 is formed into a flat shape in which an upper wall 11a and a lower wall 11b are arranged close to each other. The pump module 12 includes a flange 13 which is detachably attached to an opening 11c formed on the upper wall 11a of the tank body 11. The flange 13 is fixed by a cap 14 which is screwed to a periphery of the opening 11c of the tank body 11. On a lower face of the flange 13, a reservoir unit 16 is movably supported via an extensible connecting unit 15 so that the reservoir unit 16 can be freely moved in a vertical direction.

The reservoir unit 16 includes a reservoir 17 which is formed into a container shape having an opened upper, a motor-integrated fuel pump 18 which is housed inside the reservoir 17, and an arcuate strainer case 19 which is arranged so as to partially surround an outer circumference of the fuel pump 18. The fuel pump 18 pumps up the fuel through a pump filter 20, and supplies thus pumped fuel to an upper end of the strainer case 19 through a communicating path 21. The fuel is then purified by passing through a strainer element 22 which is housed within the strainer case 19, and is supplied to the engine via a pressure regulator 23, a fuel duct 24 and a joint 25 of the flange 13. On a lower face of the flange 13, a sub-tank 26 (a component) is integrally formed. More specifically, the sub-tank and the flange are formed in a one-piece structure. The sub-tank 26 liquidizes vaporized fuel generated in the tank body 11. On a side of the reservoir 17, a liquid level sensor 28 is provided. The liquid level sensor 28 is activated by a float 27.

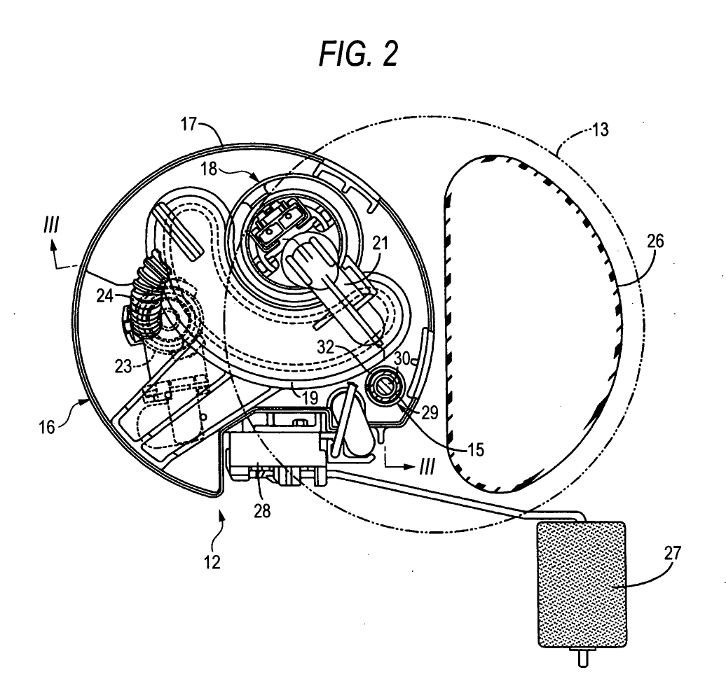

The reservoir unit 16 and the sub-tank 26 are arranged so as to be offset from each other so that they do not overlap in the plan view. An outer diameter of the reservoir unit 16 is a little smaller than an inner diameter of the opening 11c of the tank body 11. Also, a maximum diameter of the sub-tank 26 is smaller than the inner diameter of the opening 11c of the tank body 11 (see FIG. 2). Individual heights of the reservoir unit 16 and the sub-tank 26 are lower than a distance between the upper wall 11a and the lower wall 11b of the tank body 11. However, a sum of the respective heights of the reservoir unit 16 and the sub-tank 26 is higher than the distance between the upper wall 11a and the lower wall 11b of the tank body 11 (see FIG. 1).

The extensible connecting unit 15 includes a first sliding member 29 of a pipe-shape which is slidably fitted into a support hole 17a formed in an upper portion of the reservoir 17, and a second sliding member 30 of a rod-shape. An upper end portion of the second sliding member 30 is fixed to a lower face of the flange 13. The first sliding member 29 and the second sliding member 30 are telescopically engaged, and are slidable with each other. A circlip 31 is attached to a lower end portion of the second sliding member 30, so that the second sliding member 30 does not come off from the first sliding member 29. A coil spring 32 (a biasing member) is arranged at an outer circumference of the first sliding member 29, and the first sliding member 29 is biased by an elastic force of the coil spring 32 in a direction where the first sliding member 29 protrudes upward from the reservoir 17. An extensible distance of the extensible connecting unit 15 is set at a distance that is longer than the height of the sub-tank 26.

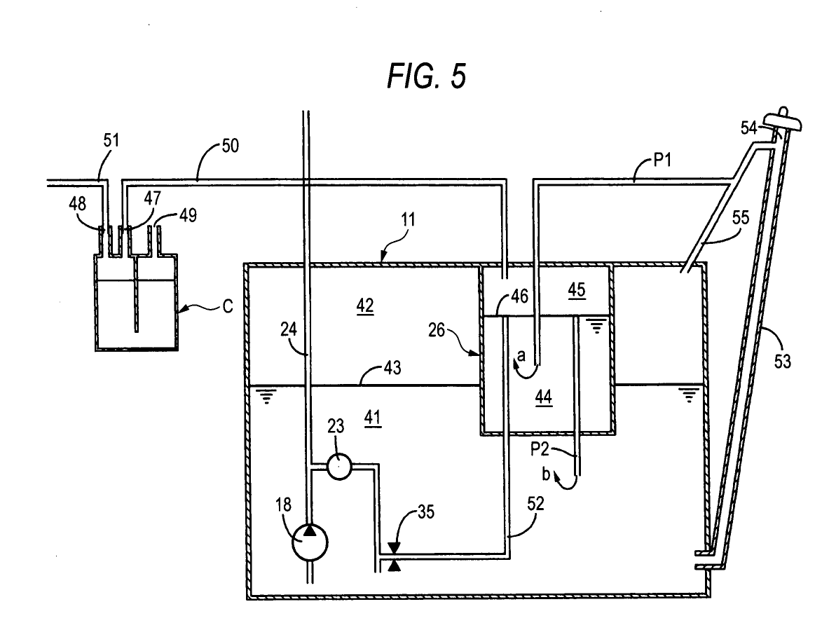

FIG. 5 is a schematic view showing a structure of the tank body 11 and the sub-tank 26. An interior of the tank body 11 is divided into a liquid-phase portion 41 filled with fuel and a gas-phase portion 42 filled with vaporized fuel. Respective volumes of the liquid-phase portion 41 and the gas-phase portion 42 change when a fuel level 43 is changed by the replenishment or consumption of the fuel. An interior of the sub-tank 26 is divided into a liquid-phase portion 44 filled with fuel and a gas-phase portion 45 filled with vaporized fuel, and a fuel level 46 is substantially constant. The gas-phase portion 42 inside the tank body 11 and the liquid-phase portion 44 inside the sub-tank 26 are connected to each other by a first communicating passage P1. The gas-phase portion 45 inside the sub-tank 26 and the liquid-phase portion 41 inside the tank body 11 are connected to each other by a second communicating passage P2.

A canister C is capable of adsorbing vaporized fuel. The canister C includes a charge port 47, a purge port 48, and a drain port 49. The charge port 47 is connected to the gas-phase portion 45 inside the sub-tank 26 by a charge passage 50. The purge port 48 is connected to a suction passage of an engine (not shown) via a purge passage 51. The drain port 49 is opened to atmosphere.

A fuel replenishing passage 52 is connected to the sub-tank 26, and is branched via the pressure regulator 23 which adjusts pressure of the fuel discharged from the fuel pump 18. A height where the fuel replenishing passage 52 is opened to the interior of the sub-tank 26 is set to be the same as a height where the second communicating passage P2 is opened to the sub-tank 26. This height is the height of the fuel level 46 of the sub-tank 26. An orifice 35 is formed on the fuel replenishing passage 52. Most of the fuel that passes through the pressure regulator 23 returns to the interior of the tank body 11. However, some of the fuel passes through the orifice 35, and is supplied to the sub-tank 26. The height where the fuel replenishing passage 52 is opened to the sub-tank 26 may be higher than the height where the second communicating passage P2 is opened to the sub-tank 26.

In the vicinity of a fuel filler port 54 which is provided at an upper end portion of a filler tube 53 extending upward from the tank body 11, the filler tube 53 is connected to the gas-phase portion 42 of the tank body 11 via a vaporized fuel returning passage 55. When fuel is supplied from the fuel filler port 54 to the filler tube 53 with a fuel filler gun, the vaporized fuel returning passage 55 returns the vaporized fuel from the gas-phase portion 42 of the tank body 11 to the vicinity of the fuel filler port, and thus returned fuel is returned into the tank body 11 together with the fuel squirted from the fuel filler gun, whereby outside air is prevented from being aspirated into the tank body 11.

According to the exemplary embodiment, the first communicating passage P1 is not directly connected to the gas-phase portion 42 of the tank body 11 but indirectly connected via the vaporized fuel returning passage 55. Referring to FIG. 1, joints 33, 34 which penetrate the flange 13 and extend upward from the sub-tank 26 are respectively connected to the charge passage 50 and the first communicating passage P1.

Next, actions of the exemplary embodiment having the above described configuration will be explained below.

When a temperature of the fuel tank becomes high in accordance with a rise of the outside air temperature in the daytime, a temperature of the tank body 11 becomes higher than a temperature of the sub-tank 26. Accordingly, the number of moles of an air-fuel mixture that can exist in the gas-phase portion 42 of the tank body 11 decreases. At the same time, in accordance with an increase in a fuel vapor pressure, vaporized fuel is generated from the liquid-phase portion 41 to the gas-phase portion 42 of the tank body 11. As a result, the air-fuel mixture in the gas-phase portion 42 of the tank body 11 is discharged into the liquid-phase portion 44 of the sub-tank 26 as bubbles via the first communicating passage P1 (see arrow “a” in FIG. 5). A partial pressure of the vaporized fuel supplied from the tank body 11 is higher than a partial pressure of the vaporized fuel existing in the sub-tank 26. Therefore, the vaporized fuel supplied from the tank body 11 is liquidized and dissolved in the liquid-phase portion 44 of the sub-tank 26 in accordance with a difference between the partial pressures. Due to the foregoing, a ratio of the vaporized fuel charged into the canister C via the charge passage 50 with respect to the vaporized fuel generated in the gas-phase portion 42 of the tank body 11 is reduced, whereby enabling to downsize the canister C.

On the other hand, when the temperature of the fuel tank becomes low in accordance with a decrease of the outside air temperature in the nighttime, the temperature of the tank body 11 becomes lower than the temperature of the sub-tank 26. Accordingly, the number of moles of the air-fuel mixture that can exist in the gas-phase portion 42 of the tank body 11 increases. At the same time, in accordance with a decrease in the fuel vapor pressure, the vaporized fuel is liquidized from the gas-phase portion 42 to the liquid-phase portion 41 of the tank body 11. As a result, the air-fuel mixture of the gas-phase portion 45 of the sub-tank 26 is introduced into the liquid-phase portion 41 of the tank body 11 via the second communicating passage P2 (see arrow “b” in FIG. 5).

As described above, when the vaporized fuel in the gas-phase portion 45 of the sub-tank 26 is aspirated by the negative pressure generated in the gas-phase portion 42 of the tank body 11, the vaporized fuel charged in the canister C is purged by the outside air aspirated through the drain port 49 of the canister C. Thus purged vaporized fuel flows into the gas-phase portion 45 of the sub-tank 26 via the charge passage 50, and returns to the liquid-phase portion 41 of the tank body 11 and liquidized. That is, a so-called back-purge can be performed. When the back-purge is performed while an engine is being stopped, it is possible to reduce a quantity (weight) of the vaporized fuel charged into the canister C. Therefore, when the vaporized fuel is purged from the canister C into the engine suction passage while the engine is being operated, it is possible to reduce a quantity of the vaporized fuel contained in the purging air, whereby accuracy of an air-fuel ratio control of the engine can be less affected.

In the back-purge performance, a concentration of the vaporized fuel in the air-fuel mixture supplied from the canister C to the gas-phase portion 45 of the sub-tank 26 is relatively low. Therefore, in accordance with the fuel vapor pressure of the gas-phase portion 45 of the sub-tank 26, the generation of the vaporized fuel from the liquid-phase portion 44 is facilitated, and the fuel constituent changes. Accordingly, the fuel vapor pressure of the gas-phase portion 45 of the sub-tank 26 is decreased, whereby the liquidization of the vaporized fuel supplied from the tank body 11 to the sub-tank 26 can be more effectively facilitated when the temperature of the tank body 11 becomes high.

The back-purge described above occurs also in a fuel tank that has no sub-tank. However, in such a case, a relatively low concentration of vaporized fuel which is purged from the canister is supplied to the fuel tank. Therefore, a quantity of the vaporized fuel dissolved in the liquid-phase portion in the fuel tank is relatively small. On the other hand, in the exemplary embodiment, the vaporized fuel purged from the canister C flows via the sub-tank 26, thereby supplying an increased concentration of vaporized fuel to the tank body 11. As a result, a quantity of the vaporized fuel that is recovered by being dissolved in the liquid-phase portion 41 of the tank body 11 becomes relatively large.

When the fuel level 46 of the sub-tank 26 becomes lower than an open end of the first communicating passage P1, the vaporized fuel supplied from the tank body 22 through the first communicating massage P1 can not be directly introduced into the liquid-phase portion 44 of the sub-tank 26. In addition, the fuel in the liquid-phase portion 44 can not be returned into the tank body 11 through the second communicating passage P2. Accordingly, there is a possibility that the fuel ages and the fuel constituent changes. In order to solve such a problem, fresh fuel is supplied from the fuel pump 18 to the sub-tank 26 through the regulator 23 and the fuel replenishing passage 52. When the fuel level 46 of the sub-tank 26 becomes higher than an opening portion at an upper end of the second communicating passage P2 by the fuel supplied from the fuel replenishing passage 52, the surplus fuel is returned to the tank body 11 through the second communicating passage P2. In this way, the fuel level 46 of the sub-tank 26 is kept constant.

As described above, the vaporized fuel is liquidized in the sub-tank 26 when the temperature of the tank body 11 becomes high, and the vaporized fuel is liquidized in the tank body 11 and at the same time the fuel vapor pressure in the sub-tank 26 is decreased when the temperature of the tank body 11 becomes low. Due to the foregoing, the liquidization of the vaporized fuel in the sub-tank 26 is facilitated when the temperature of the tank body 11 subsequently becomes high, and the generation of the vaporized fuel can be effectively suppressed even when the tank body 11 and the sub-tank 26 are at any temperatures. As a result, it is possible to prevent the vaporized fuel from dispersing into the atmosphere even when a capacity of the canister C is reduced. Further, a quantity of the vaporized fuel purged from the canister C into a suction system of the engine can be reduced, whereby the accuracy of air-fuel ratio control of the engine is enhanced.

Next, explanations will be given on the assembling of the pump module 12 to the tank body 11.

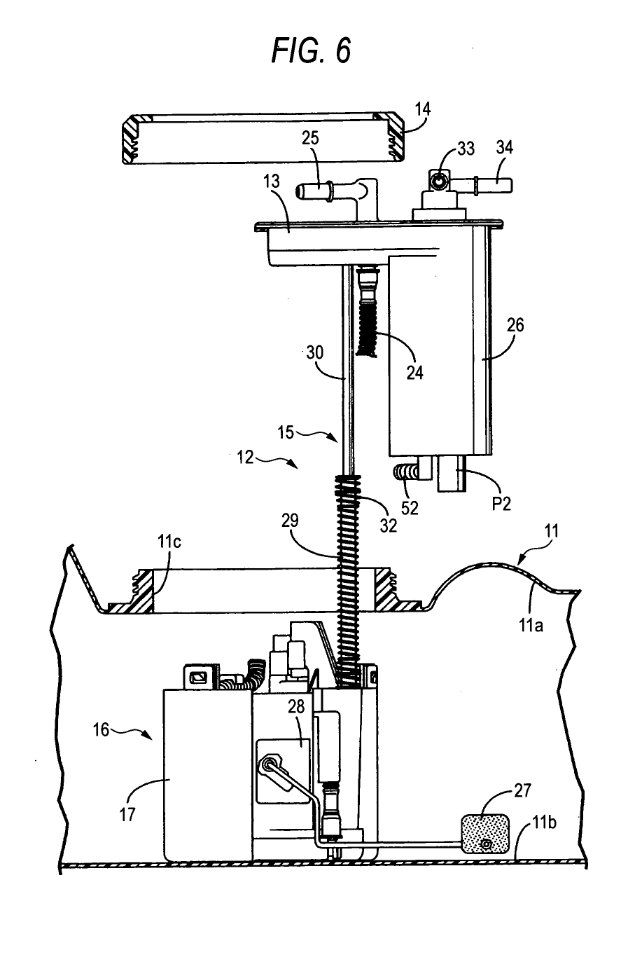

As shown in FIG. 6, the cap 14 is removed from the tank body 11 so as to expose the opening 11c. In this state, the reservoir unit 16 of the pump module 12 is inserted into the tank body 11 through the opening 11c. At this time, the first and the second sliding member 29, 30 of the extensible connecting unit 15 are most extended. Therefore, a lower end portion of the sub-tank 26 provided on the lower face of the flange 13 is located at a position that is higher than an upper face of the opening 11c.

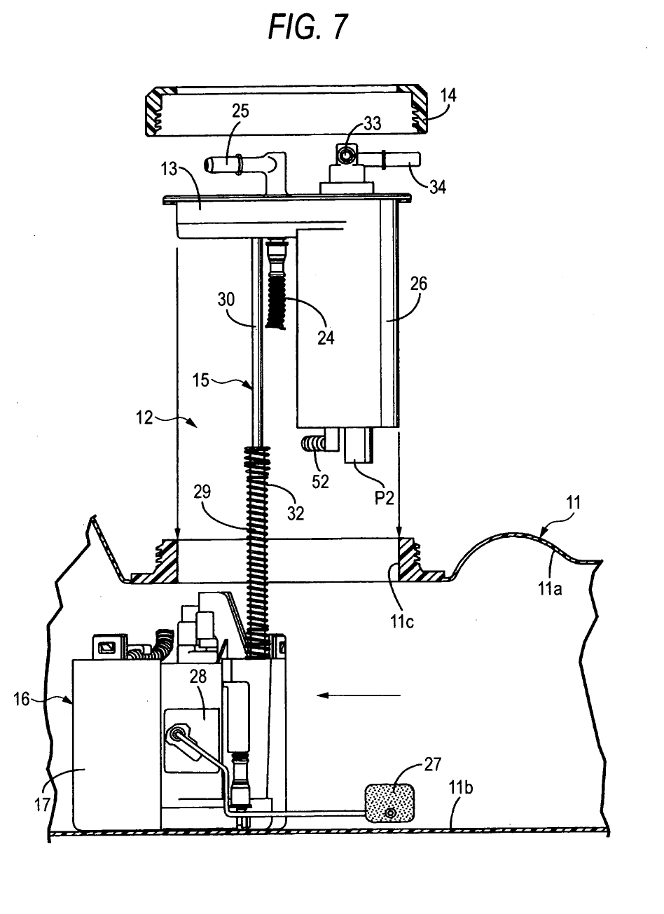

Next, as shown in FIG. 7, the reservoir unit 16 is slid in the lateral direction inside the tank body 11 so that the flange 13 is located right above the opening 11c. From this state, the flange 13 is made to descend while the second sliding member 30 of the extensible connecting unit 15 is being engaged with the inside of the first sliding member 29, and a lower half portion of the sub-tank 26 is inserted into the tank body 11 through the opening 11c. When the second sliding member 30 of the extensible connecting unit 15 completely engages with the first sliding member 29, the flange 13 is further made to descend. Then, the first sliding member 29 pushed into the reservoir 17 while the coil spring 32 is being compressed by the first sliding member 29. Finally, the sub-tank 26 is installed inside the tank body 11, and the flange 13 engages with the opening 11c. Accordingly, as shown in FIG. 1, the pump module 12 having the reservoir unit 16 and the sub-tank 16 is assembled inside the tank body 11 by screwing the cap 14 to the opening 11c.

In this state in which the pump module 12 is assembled as described above, an elastic force of the coil spring 32 acts such that the reservoir unit 16 is biased downward with respect to the flange 13. Therefore, even when the distance between the upper wall 11a and the lower wall 11b increases or decreases due to a change in an inner pressure of the tank body 11, a lower face of the reservoir unit 16 is pushed onto the lower wall 11b of the tank body 11, thereby preventing a rattling from being occurred.

The extensible connecting unit 15 that connects the flange 13 and the reservoir unit 16 includes the first and the second sliding member 29, 30 that are connected to have a two-stage structure. Therefore, it is possible to ensure a sufficiently long relative movement between the flange 13 and the reservoir unit 16. As a result, even in case where a vertical dimension of the sub-tank 26 is large, it is possible to prevent the lower end portion of the sub-tank 26 from interfering with the opening 11c of the tank body 11 when sliding the reservoir unit 16 in the horizontal direction inside the tank body 11 (see FIG. 7). Therefore, the pump module 12 can be assembled without causing any problems. When the assembling is completed, the reservoir unit 16 and the sub-tank 26 are arranged in parallel with each other in the lateral direction but not in the vertical direction. Therefore, the reservoir unit 16 and the sub-tank 26 can be assembled to the tank body 11 which has a small vertical dimension. Further, since the first and the second sliding member 29, 30 are telescopically engaged with each other, the reservoir unit 16 can be guided in the vertical direction with respect to the flange 13 in a simple structure.

Since the sub-tank 26 is not arranged outside the tank body 11, but is arranged inside the tank body 11 integrally with the reservoir unit 16, means for fixing the sub-tank 26 to the outside of the tank body 11, e.g., an attaching bracket, becomes unnecessary. Further, it is unnecessary to arrange the second communicating passage P2 for communicating the gas-phase portion 45 of the sub-tank 26 with the liquid-phase portion 41 of the tank body 11 outside the tank body 11. It is also unnecessary to arrange the fuel replenishing passage 52 for communicating the pressure regulator 23 with the gas-phase portion 45 of the sub-tank 26 outside the tank body 11. Accordingly, a connecting work for the second communicating passage P2 and the fuel replenishing passage 52 is not required when mounting the tank body 11 to a vehicle body. Further, the vaporized fuel is prevented from dispersing into the atmosphere through the second communicating passage P2 and the fuel replenishing passage 52. Especially, since the pump module 12 is configured such that the reservoir unit 16 and the sub-tank 26 are integrated with each other, the assembling of the reservoir unit 16 and the sub-tank 26 can be completed only by assembling the pump module 12 to the tank body 11. Accordingly, it is possible to reduce the number of man-hours required for assembling.

It is sufficient that the opening 11c of the tank body 11 is formed into a size through which the reservoir unit 16 an the sub-tank 26 can be inserted individually, and it is unnecessary that the opening 11c of the tank body 11 is formed into a size through which both the reservoir unit 16 and the sub-tank 26 can be simultaneously inserted together. Therefore the size of the opening 11c can be minimized. As a result, a quantity of the vaporized fuel transmitting through a periphery of the flange 13 that closes the opening 11c can be reduced. Accordingly, a leakage of the vaporized fuel from the overall fuel tank can be minimized.

The first and the second sliding members 29, 30 need not be engaged telescopically, and any structure may be adopted as long as the first and the second sliding member are slidable with each other.

Further, although the first and the second sliding members 29, 30 of a telescopic type are adopted so that they can be fitted to the flat tank body 11, a vertically long module, in which the sub-tank 26 and the reservoir unit 16 are simply placed in a vertical direction one above the other, may be adopted if a height of the tank body 11 is sufficiently high.

A structure of the sub-tank 26 need not be the structure shown in the exemplary embodiment, and any structure may be adopted as long as it is possible to liquidize the vaporized liquid.

A component arranged on the lower face of the flange 13 is not limited to the sub-tank 26 as shown in the exemplary embodiment. For example, a long float valve described in JP-A-6-297968 may be arranged on the lower face of the flange 13.

While description has been made in connection with an exemplary embodiment of the present invention, it will be obvious to those skilled in the art that various changes and modification may be made therein without departing from the present invention. It is aimed, therefore, to cover in the appended claims all such changes and modifications falling within the true spirit and scope of the present invention.

What is claimed is:

1. A fuel tank comprising:
a component;
a reservoir unit having a fuel pump;
a tank body formed with an opening through which the reservoir unit and the component are inserted;
a flange operable to close the opening; and
an extensible connecting unit which connects a lower face of the flange and the reservoir unit, and includes:
a first sliding member which is slidable with respect to the reservoir unit in a vertical direction; and
a second sliding member which is slidable with respect to the first sliding member, and is attached to the lower face of the flange,
wherein the component is disposed on the lower face of the flange at a position that is offset with respect to the reservoir unit in a horizontal direction,
a height of the tank body is shorter than a sum of respective heights of the component and the reservoir, and
the opening has a size, through which the reservoir unit and the component can be individually inserted, and through which the reservoir unit and the component can not be simultaneously inserted.

2. The fuel tank cording to claim 1, wherein the first sliding member and the second sliding member are telescopically engaged with each other.

3. The fuel tank cording to claim 1, further comprising a biasing member operable to bias the first sliding member in a direction where the first sliding member protrudes upward from the reservoir.

4. The fuel tank according to claim 1, further comprising a cap that is attachable to a periphery of the opening, wherein the flange is fixed between the cap and the tank body.

5. The fuel tank according to claim 1, wherein the component includes a sub-tank operable to liquidize vaporized fuel generated in the tank body and to return the liquidized fuel into the tank body.

6. The fuel tank according to claim 1, wherein the component and the flange are formed in a one-piece structure.

7. A fuel tank comprising:
a tank body operable to store fuel; and
a pump module operable to pump the fuel,
wherein the pump module includes a sub-tank operable to liquidize vaporized fuel generated in the tank body and to return the liquidized fuel into the tank body, and
the sub-tank is disposed inside the tank body.

8. The fuel tank according to claim 7, wherein the pump module further comprises:
a flange operable to close an opening that is formed on the tank body;
a reservoir unit; and
an extensible connecting unit which connects a lower face of the flange and the reservoir unit, and includes:
a first sliding member which is slidable with respect to the reservoir unit in a vertical direction; and
a second sliding member which is slidable with respect to the first sliding member, and is attached to the lower face of the flange,
wherein the sub-tank is disposed on the lower face of the flange at a position that is offset with respect to the reservoir unit in a horizontal direction, and
the opening has a size, through which the reservoir unit and the sub-tank can be individually inserted, and through which the reservoir unit and the sub-tank can not be simultaneously inserted.

9. The fuel tank according to claim 7, wherein the sub-tank and the flange are formed in a one-piece structure.

10. The fuel tank according to claim 7, further comprising a cap that is attachable to a periphery of the opening, wherein the flange is fixed between the cap and the tank body.
